(19) United States
(12) Patent Application Publication
(10) Pub. No.: US 2021/0406824 A1
(43) Pub. Date: Dec. 30, 2021

(54) SYSTEMS AND TECHNIQUES FOR SHARING SHIPMENT DATA

(71) Applicant: CoffeeChain, LLC, Camden, DE (US)

(72) Inventor: Alexander DuPont Barrett, Medellin (CO)

(73) Assignee: CoffeeChain, LLC

(21) Appl. No.: 16/917,520

(22) Filed: Jun. 30, 2020

(51) Int. Cl. G06Q 10/08; G06Q 30/02

(52) U.S. Cl. CPC G06Q 10/08345; G06Q 10/0875; G06Q 10/0833; G06Q 30/0283

(57) ABSTRACT

This disclosure describes, in part, systems and techniques for sharing shipment data. For instance, a user associated with a mill may input, into a device, a gross weight and a factor for a shipment. The device may then use the inputs to determine the green weight for the shipment as well as a total price that is to be paid to a producer of the shipment. Next, the device may then send data representing the information to a system. Using the data, the system may generate a ledger for the shipment. The system may then continue to receive data from other users included in the supply chain for the shipment and add additional information to the ledger. Additionally, the system may send the ledger to the other users so that all of the users in the supply chain may determine the current status of the shipment.

### BACKGROUND

Traditionally, when exporting products, farmers take their shipments to mills for weighing before the shipments are exported. For example, a coffee farmer may take a shipment of coffee beans to a mill. At the mill, the shipment is initially weighed, where the initial weight of the shipment is used to determine the green weight of the coffee beans. This green weight of the coffee beans is then used to pay the farmer for the shipment. However, it is currently difficult to determine the price that the farmer is getting paid since the farmer's price is included within the total export price of the shipment. This is because current systems that track shipments do not include the technology to provide the farmers' prices.

### BRIEF DESCRIPTION OF FIGURES

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example of a mill inputting data associated with a shipment and a producer approving the data.

FIG. 2 illustrates an example of the mill inputting information associated with the shipment of FIG. 1.

FIG. 3 illustrates an example of the producer viewing information associated with the shipment of FIG. 1.

FIG. 4 illustrates an example of viewing a supply chain ledger associated with the shipment of FIG. 1.

FIG. 5 illustrates an example user interface for selecting users associated with a supply chain for the shipment of FIG. 1.

FIG. 6 illustrates an example environment that includes various devices communicating in order to provide information associated with the shipment from FIG. 1.

FIGS. 7A-7B are an example process for inputting data associated with a shipment into an electronic device.

FIG. 8 is an example process for approving data associated with a shipment.

FIG. 9 illustrates an example of an importer creating an offer that is to be fulfilled by at least one exporter.

FIG. 10 illustrates an example of an exporter accepting the offer from the example of FIG. 9.

FIG. 11 illustrates an example of the importer now accepting the offer from the example of FIG. 9.

FIG. 12 illustrates an example of the exporter creating an order for the accepted offer from FIGS. 9-11.

FIG. 13 illustrates an example of the mill viewing the order from FIG. 12 before inputting the necessary information.

FIG. 14 illustrates an example of the exporter viewing the order after the farmer has accepted the data input by the mill in the example of FIG. 13.

FIG. 15 illustrates an example computer architecture diagram showing an exemplary computer hardware architecture for implementing an electronic device that may be utilized to implement aspects of the various technologies presented herein.

### DETAILED DESCRIPTION

As discussed above, traditionally, when exporting products, farmers take their shipments to mills for weighing before the shipments are exported. For example, a coffee farmer may take a shipment of coffee beans to a mill. At the mill, the shipment is initially weighed, where the initial weight of the shipment is used to determine the green weight of the coffee beans. This green weight of the coffee beans is then used to pay the farmer for the shipment. However, it is currently difficult for other users included in the supply chain to determine the price that the farmer is getting paid since the farmer's price is included within the total export price of the shipment. This is because current systems that track shipments do not include the technology to provide these farmers' prices. Because of this lack of technology, there is a potential for fraud along the supply chains for the shipments.

As such, the present disclosure is directed to systems and devices that generate and provide information about shipments. This information may then be shared with users included in the supply chains of the shipments. For example, if the shipment is for coffee, this information may be provided to the users of the coffee supply chain, such as the producer (e.g., the farmer), the mill, the exporter, the importer, the roaster, the barista, the consumer, and/or so forth. The information may include at least the gross weight of the shipment, a factor (e.g., the mill percentage) associated with the shipment, the green weight of the shipment, the price unit weight that the producer is gettering paid, and the total price for the producer. As such, these systems and devices may reduce the amount of fraud that can occur along the supply chain for the shipment.

For more detail, a producer may arrive at a mill with a shipment of products. The products may include, but are not limited to, coffee beans, fruit, vegetables, electronics, furniture, and/or any other type of product that may be shipped. Either before or when the producer arrives at the mill, the price that the producer is to be paid may be determined and input into the system. For example, before the producer arrives at the mill, the exporter and the producer may determine a price per unit weight that the producer will be paid when delivering the shipment. The exporter and/or the farmer may then use a device to input the price, where the device then sends data representing the price to the system for storage. This inputted price may then be used to determine the total price that the producer is paid for the shipment.

For instance, at the mill, the shipment may be weighed to determine a gross weight for the shipment. In some instances, such as when the products include coffee beans, a factor (e.g., percentage, ratio, etc.) may be determined for the shipment. In such instances, the factor may be determined based on the quality of the products included within the shipment. For instance, a new factor may be determined for each shipment that arrives at the mill, even if the same producer brings multiple shipments. This factor is then used to determine a green weight for the shipment. In some instances, a user associated with the mill determines the green weight by multiplying the gross weight by the factor. The user associated with the mill may then use a device (which may be referred to, in these examples, as a “first device”) to input information associated with the shipment.

For example, the first device may provide a user interface (which may be referred to, in these examples, as a “first user interface”) to the user. The first user interface may include a number of interface elements that allow the user to input the information associated with the shipment. For example, the first user interface may include at least a first interface element for inputting the gross weight of the shipment and a second interface element for inputting the factor. The first user interface may also include information that was previously provided to the system. For example, the system may send, to the first device, data representing the price for the producer. The first device may then use that data to input the price into a third interface element of the first user interface. Using the information, the first device may then determine the total price that the producer is to receive for the shipment.

For example, and in instances where the factor is provided for the shipment, the first device may determine the green weight for the shipment. As discussed above, and in some instances, the first device determines the green weight by multiplying the gross weight by the factor. The first device may then determine the total price for the producer using the green weight and the price per unit weight for the producer. In some instances, the first device determines the total price by multiplying the green weight by the price per unit weight. The first device may then update the first user interface to include the green weight and the total price. For example, the first device may input the green weight into a fourth interface element of the first user interface and input the total price into a fifth interface element of the first user interface.

In some instances, the first device determines the prices in the local currency of the producer. For a first example, if the producer and/or mill are based in Brazil, the first device may determine the price per unit weight and/or the total price in the Brazilian Real. For a second example, if the producer and/or the mill are based in Columbia, the first device may determine the price per unit weight and/or the total price in the Columbian Peso. Still, a third example, if the producer and/or the mill are based in the United States, the first device may determine the price per unit weight and/or the total price in the US Dollar. In either of these examples, the first device may cause the first user interface to provide the prices in the local currency of the producer.

Once the user associated with the mill has finished inputting the information for the shipment, the first device may receive, using the first user interface, an input indicating that the user is finished. Based on the input, the first device may send data representing the information to the system. The system may then store this data in association with the shipment. For example, the shipment may be associated with a code, such as a Quick Response (QR) code, that the users included in the supply chain may use to view the information about the shipment, which is described in more detail below. As such, the system may store the information in association with the code such that, when users request information by providing the code, the system is able to identify the requested information and then provide the information to the users.

The system may then send data representing the information to a device (which may be referred to, in these examples, as a “second device”) associated with the producer, which may provide the information for approval. For instance, the second device may provide a user interface (which may be referred to, in these examples, as a “second user interface”) to the producer. The second user interface may include at least the information that was input into the first device and uploaded to the system. For example, the second user interface may provide at least the gross weight, the factor, the green weight, the price per unit weight for the producer, and/or the total price for the producer. The second user interface may further include a first interface element for approving the information and a second interface element for disapproving the information.

For a first example, if the producer agrees that the information is correct (e.g., the price per unit weight and the total price), then the second device may receive, using the second user interface, an input selecting the first interface element. In response, the second device may send, to the system, data indicating that the producer has approved the information, which may be stored by the system. For a second example, if the producer does not agree that the information is correct (e.g., the price per unit weight and the total price), then the second device may receive, using the second user interface, an input selecting the second interface element. In response, the second device may send, to the system, data indicating that the producer does not approve the information, which may be stored by the system.

In some instances, other users included in the supply chain can then view the information input by the mill and/or the producer. For example, the other users may be able to view the gross weight, the factor, the green weight, the price per unit weight for the producer, and/or the total price for the producer. This way, the other users can confirm that the producer was paid market value for the shipment. Additionally, the other users may use respective devices to input additional information associated with the shipment as the shipment makes its way through the supply chain. This additional information may then be viewed by each of the users included within the supply chain.

In some instances, the system may generate a ledger, such as a Blockchain ledger, associated with the shipment. For instance, each time the system receives data from a user included in the supply chain, the system may add information represented by the data to the ledger. As such, the ledger may include the initial information (e.g., the gross weight, the factor, the green weight, the price per unit weight for the producer, the total price for the producer, etc.) input at the mill, as well as additional information input by other users included in the supply chain. During and/or after creating the ledger, the system may receive one or more requests from the users to view the leger. In response, the system may provide the ledger to the one or more requesting users.

For example, if the importer wishes to view the ledger, the system may receive, from a device (which may be referred to, in these examples, as a “third device”) associated with the importer, data representing a request to view the ledger. In some instances, the data may include the code associated with the shipment. Additionally, or alternatively, in some instances, the data may include other identifying information associated with the importer and/or shipment, such as an identity (e.g., name) of the importer. The system may then use the data received from the third device to identify the ledger. For instance, the system may match the code received from the third device to the code associated with the shipment and/or ledger. After identifying the ledger, the system may send, to the third device, data representing the ledger. This way, the importer is able to view all of the information input by the mill into the system.

In some instances, the system may store data (e.g., ledgers) for multiple shipments and provide at least a portion of the data to producers, mills, exporters, importers, roasters, baristas, consumers, and/or so forth. For example, the system may store data representing the prices per unit weight that have been paid to producers of a given product, such as coffee beans. The system may then provide that information to producers of the product. This way, the producers are able to determine the prices per unit weight being paid to other producers and/or determine a fair market value for the products. This can reduce the amount of fraud within supply chains, as each user may determine fair market values.

In some instances, the system may allow for traceability between the users included in the supply chain. For example, the system may allow the users to create self-sovereign identities (SSIs) that the users can use when communicating with one another. The SSI associated with a user may include credentials that the user is able to use to securely communicate with at least a second user included in the supply chain. In some instances, the system also stores information associated with each of the users in the supply chain and provides the information to authorized users. In some instances, the authorized users include the other users that are included in the supply chain.

This way, each user include in the supply chain is able to receive, view, and use information about the other users included in the supply chain. This makes it easy for users included in the supply chain to track the progress of the products through the entire supply chain. This also makes it easy for the other users included in the supply chain to communicate with one another, such as to ask questions about the products and/or receive additional information associated with the products. In some instances, the system may send this information to other users upon receiving a request for the information. In some instances, the system may initially determine that the requesting user includes an authorized user, such as by determining that the user is included in the supply chain.

Additionally, in some instances, the systems may use the data associated with the users to automatically input information into the user interfaces described herein. For instance, the systems may use the data associated with a producer (e.g., the farmer) to input the information for the producer for supply chains in which the producer is included. Additionally, the systems may use the data associated with a mill to input the information for the mill for supply chains in which the mill is included. This may help streamline the supply chain as each of the users' information is automatically input into the ledger such that the other users are able to determine any information that is important for the other users.

As described herein, a shipment may include any amount of product that is provided by a producer. For example, a shipment of coffee beans may include any weight for the coffee beans that a farmer provides to a mill. Additionally, an interface element may include, but is not limited to, a button, an icon, an image, content, and/or any other element that may be included on a user interface. In some instances, an interface element is interactive, such that a user can use the interface element to input information associated with a shipment. Additionally, in some instances, an interface element may not be interactive. For instance, the interface element may use other information input by a user in order to automatically update the information that is provided by the interface element.

As further described herein, a device and/or electronic device may include, but is not limited to, a mobile phone, a laptop, a computer, a tablet, and/or any other type of device. Additionally, while the examples herein describe a given electronic device as performing specific processes, in other examples, one or more other devices may perform the processes. For examples, the remote system(s) described herein may perform one or more of the processes described herein.

By performing the processes described herein, exporters and importers are able to quickly and easily create orders for shipments of products. For example, and as will be described in more detail below, an exporter is able to create an offer by importing data into an electronic device. That data is then shared with at least an exporter so that the exporter can accept the offer to create the order for the shipment and provide any necessary data back to the exporter. Additionally, the exporter is able to provide data associated with the order to one or more farmers so that the one or more farmers are able to indicate an acceptance to provide the products for the order to the mill. These processes are streamlined since each of the exporter, the importer, the one or more farmers, and the mill are able to use respective user interfaces that not only provide all the necessary data required by the users, but also allow the users to provide any additional data that is to be shared.

Additionally, by allowing the data input by all of the users to be shared with all of the other users, the processes described here reduce the amount of fraud that may occur during the supply chain. For example, each of the other users is able to determine the farm price that is to be paid to the farmer(s) that provide the product for the order. This farm price is automatically determined by the system(s) and/or electronic device(s) using data that is input by the farmer(s), the exporter, and/or the mill and then provided to each of the users. As such, the other users are able to ensure that the farmer(s) are paid the correct price(s) for all of their deliveries.

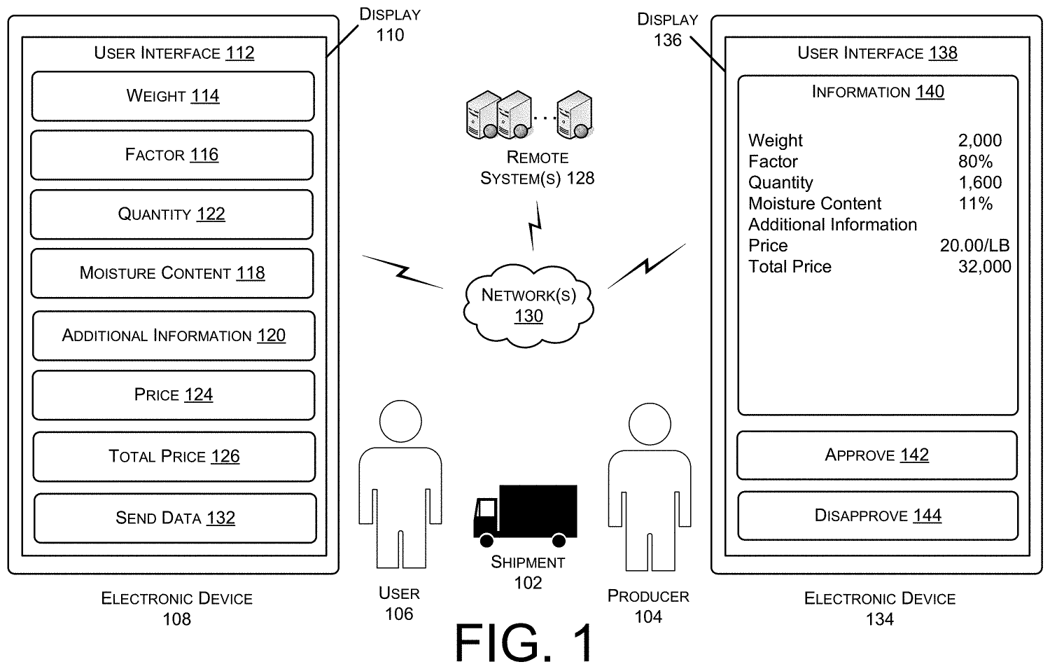

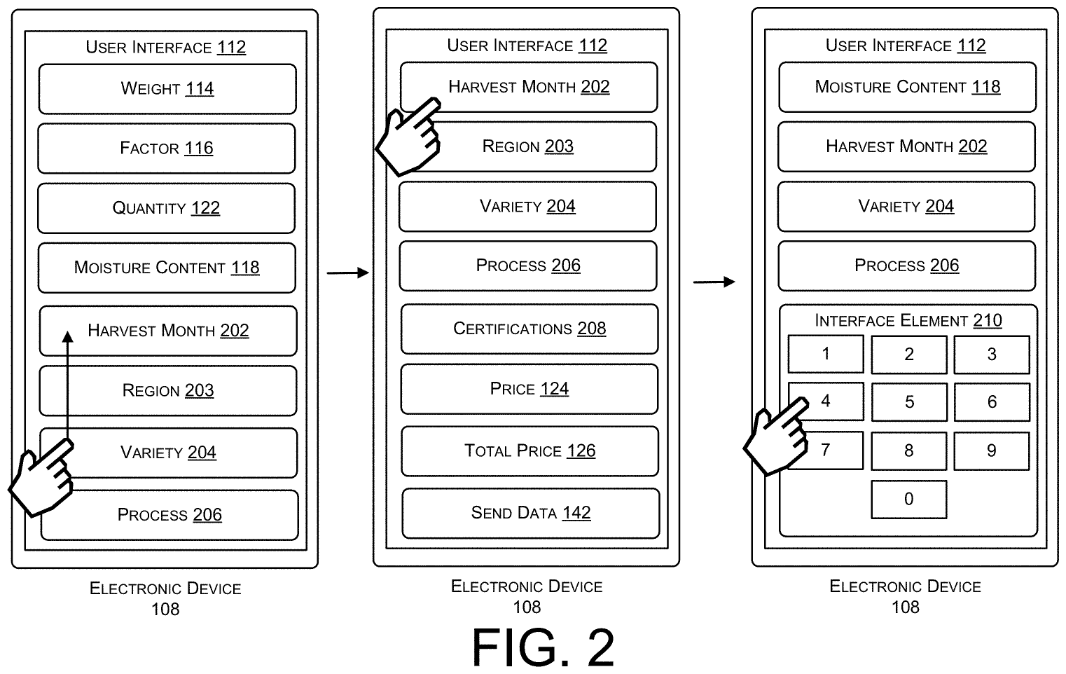

FIG. 1 illustrates an example of a mill inputting data associated with a shipment 102 and a producer 104 approving the data. For instance, a user 106 at the mill may use an electronic device 108 to input the data associated with the shipment 102. As shown, the electronic device 108 may provide, using a display 110, a user interface 112 for inputting the data. For instance, the user interface 112 may include a first interface element for inputting a weight 114 (e.g., the gross weight) of the shipment 102, a second interface element for inputting a factor 116 for the shipment 102, a third interface element for inputting a moisture content 118 for the shipment 102, and a fourth interface element for inputting additional information 120 for the shipment 102, which is described in more detail with regard to FIG. 2. The user interface 112 further includes a fifth interface element that provides a quantity 122 (e.g., green weight) for the shipment 102, a sixth interface element that provides a price 124 (e.g., price per unit weight) for the producer 104, and a seventh interface element that provides a total price 126 for the producer 104.

For an example of inputting the information, the electronic device 108 may receive data representing the price 124 for the producer. In some instances, the electronic device 108 receives the data from another device, such as remote system(s) 128 via network(s) 130. The electronic device 108 may then update the sixth interface element to include the price 124. Next, the electronic device 108 may receive a first input indicating the weight 114 and a second input indicating the factor 116. In some instances, the electronic device 108 receives the inputs from the user 106 (e.g., manual inputs). In other instances, the electronic device 108 receives the inputs from another device, such as a scale that weighs the shipment 102. In either instance, and based on the inputs, the electronic device 108 may update the first interface element to include the weight 114 and the second interface element to include the factor 116. The electronic device 108 may then perform one or more calculations to determine the total price 126 that is to be provided to the producer 104 for the shipment 102.

For example, the electronic device 108 may use the weight 114 and the factor 116 to determine the quantity 122 of the shipment 102. In some instances, the electronic device 108 determines the quantity 122 by multiplying the weight 114 by the factor 116. The electronic device 108 may then update the fifth interface element to include the quantity 122. Additionally, the electronic device 108 may use the quantity 122 and the price 124 to determine the total price 126 for the shipment 102. In some instances, the electronic device 108 determines the total price 126 by multiplying the quantity 122 by the price 124. The electronic device 108 may then update the seventh interface element to include the total price 126 for the producer 104.

Once the user 106 has input the information and the electronic device 108 has performed the calculations, the electronic device 108 may receive, using an eighth interface element of the user interface 112, an input associated with sending data 132. Based on the input, the electronic device 108 may generate and/or send the data representing the inputted information to one or more devices, such as the remote system(s) 128 via the network(s) 130. As discussed below, the remote system(s) 128 may then store the data in association with the shipment 102 so that other users included in the supply chain for the shipment 102 are able to view the information. For example, the remote system(s) 128 may generate a ledger for the shipment 102 that the other users are able to view.

For example, the remote system(s) 128 may send, to an electronic device 134 associated with the producer 104, the data representing the information. As shown, the electronic device 134 may provide, using a display 136, a user interface 138 that includes information 140 represented by the data. For instance, the information 140 may include at least the weight 114 of the shipment 102, the factor 116 for the shipment 102, the quantity 122 for the shipment 102, the moisture content 118 of the shipment 102, the additional information 120 for the shipment 102, the price 124 for the producer 104, and the total price 126 for the producer 104. The producer 104 may then use the electronic device 134 to verify that the information 140 for the shipment 102 is correct.

For instance, the user interface 138 includes a first interface element to approve 142 the information 140 and a second interface element to disapprove 144 the information 140. For a first example, if the producer 104 agrees that the information 140 is correct (e.g., the price 124 and the total price 126), then the electronic device 134 may receive, using the user interface 138, an input selecting the first interface element to approve 142 the information 140. In response, the electronic device 134 may send, to the remote system(s) 128 via the network(s) 130, data indicating that the producer 104 has approved the information 140, which may be stored by the remote system(s) 128. For a second example, if the producer 104 does not agree that the information 140 is correct (e.g., the price 124 and the total price 126), then the electronic device 134 may receive, using the user interface 138, an input selecting the second interface element to disapprove 144 the information 140. In response, the electronic device 134 may send, to the remote system(s) 128 via the network(s) 130, data indicating that the producer 104 has disapproved the information 140, which may be stored by the remote system(s) 128.

The remote system(s) 128 may store the data representing whether the producer 104 approved or disapproved of the information 140. Additionally, in some instances, the remote system(s) 128 may send, via the network(s) 130, the data to the electronic device 108. This way, the user 106, as well as the other users included in the supply chain, are also able to determine whether the producer 104 approved or disapproved of the information 140, such as in the ledger.

FIG. 2 illustrates an example of the mill inputting information associated with the shipment of FIG. 1. As shown by the left illustration of the electronic device 108, the electronic device 108 may initially provide the user interface 112 with a first portion of the interface elements. As shown, the first portion of the interface elements may be associated with the weight 114, the factor 116, the quantity 122, the moisture content 118, a harvest month 202 for the shipment 102, a region 203 at which the harvest occurred, a variety 204 for the shipment 102, a process 206 for the shipment 102, and a certification 208 for the shipment 102. In some instances, the interface elements for the harvest month 202, variety 204, the process 206, and the certification 208 may correspond to the interface element for the additional information 120 from the example of FIG. 1.

While providing the first portion of the interface elements, the electronic device 108 may receive an input associated with viewing a second portion of the interface elements, which is represented by the hand swiping in the upward directions on the display 110. In response, the electronic device 108 may provide the second portion of the interface elements, which is shown by the middle illustration of the electronic device 108. In some instances, the electronic device 108 provides the second portion of the interface elements by scrolling downward through the interface elements. As shown, the second portion of the interface elements may be associated with the moisture content 118, the harvest month 202, the variety 204, the process 206, the certification 208, the price 124, the total price 126, and the send data 142.

Next, the electronic device 108 may receive an input associated with selecting the interface element associated with the moisture content 118, which is represented by the hand pressing the interface element. In response, the electronic device 108 may provide an interface element 210 for inputting information for the moisture content 118. In the example of FIG. 2, the interface element 210 includes a keypad. However, in other examples, the interface element 210 may include any other type of input, such as a keyboard. Additionally, in some instances, the electronic device 108 may provide the interface element 210 for inputting other types of information, such as the weight 114, the factor 116, and/or so forth.

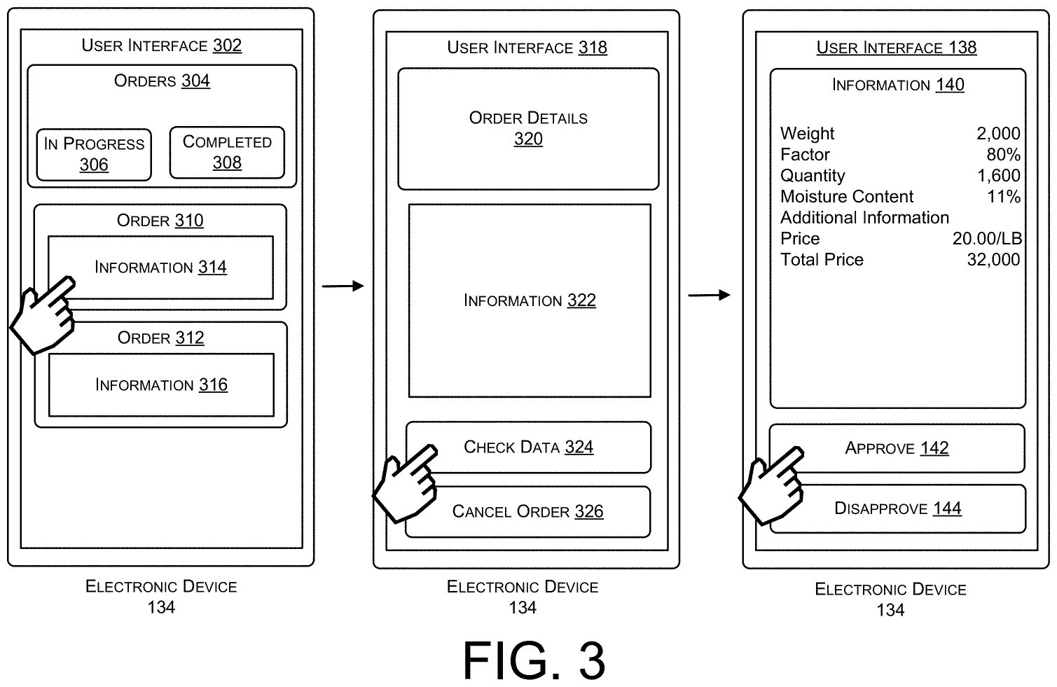

FIG. 3 illustrates an example of the producer 104 viewing information associated with the shipment of FIG. 1. As shown by the left illustration of the electronic device 108, the electronic device 134 may initially provide a user interface 302 for viewing various orders. For instance, the user interface 302 includes an indication that the user is able to view orders 304 associated with the producer 104. The indication includes a first interface element for viewing orders that are in progress 306 and a second interface element for viewing orders that have been completed 308. For example, the producer 104 can select the first interface element to view the orders that currently in progress 306 or select the second interface element to view orders that are currently completed 308.

In the example of FIG. 3, the producer 104 may have already selected the first interface element. As such, the user interface 302 is providing the orders that are currently in progress 306 for the producers 104. In the example of FIG. 3, the orders include at least a first order 310 and a second order 312. The user interface 302 also includes a third interface element for viewing information 314 associated with the first order and a fourth interface element for viewing information 316 associated with the second order. For instance, and in the example of FIG. 3, the producer 104 may select the third interface element for viewing the information 314 associated with the first order 310, which is represented by the hand selecting the third interface element.

Based on the input, the electronic device 134 may provide a user interface 318 that includes order details 320 for the first order, which is shown by the middle illustration of the electronic device 134. As shown, the user interface 318 includes initial information 322 for the first order 310. In some instances, the initial information 322 may include, but is not limited to, the total price 126, a name of the mill, an address of the mill, a contact at the mill (e.g., a name of the user 106), the quantity 122, a delivery date, a cup score, the variety 204, the certifications 208, the process 206, and/or any other type of information. The user interface 318 further includes a fifth interface element to check data 324 associated with the first order 310 and a sixth interface element to cancel the order 326.

In the example of FIG. 3, the electronic device 134 may receive an input selecting the fifth interface element to check data 324, which is illustrated by the hand selecting the fifth interface element. In response, the electronic device 134 may provide the user interface 138 from the example of FIG. 1. In some instances, such as when the producer 104 approves of the first order 310, the electronic device 134 may then receive an input selecting the interface element to approve 142 the first order 310, which is illustrated by the hand selecting the interface element.

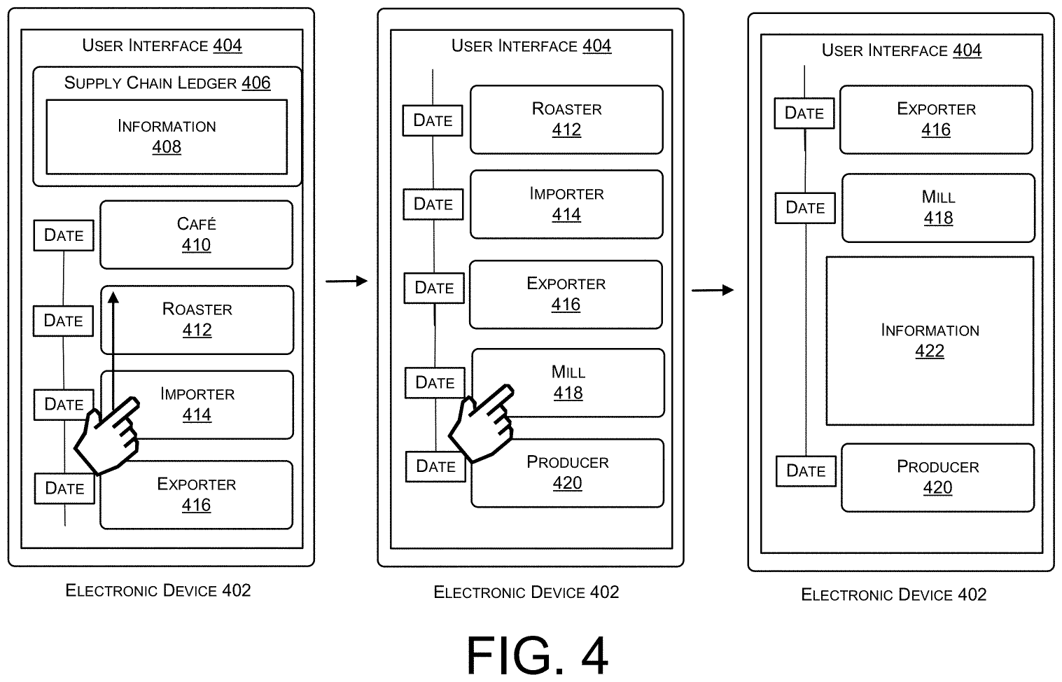

FIG. 4 illustrates an example of viewing a supply chain ledger associated with the shipment of FIG. 1. As shown by the left illustration of an electronic device 402 (which may represent, and/or include, the electronic device 108, the electronic device 134, and/or another electronic device), the electronic device 402 may initially provide a user interface 404 for viewing the supply chain ledger 406. The user interface 404 includes a first interface element that includes information 408 associated with the shipment 102. The information 408 may include, but is not limited to, the origin of the shipment 102 (e.g., the county, state, country, etc.), the quantity 122, the number of sacks, the price 124, and/or any other type of information.

The user interface 404 further includes interface elements for the various users included in the supply chain. For example, the user interface 404 initially includes a second interface element for a café 410, a third interface element for a roaster 412, a fourth interface element for an importer 414, and a fifth interface element for an exporter 416. In the example of FIG. 4, a user of the electronic device 402 may scroll through the ledger in order to identify additional users included within the supply chain. For instance, the electronic device 402 may receive an input associated with viewing the additional users, which is represented by the hand swiping in the upward directions on the electronic device 402.

In response, and as shown by the middle illustration of the electronic device 402, the electronic device 402 may provide a sixth interface element for the mill 418 and a seventh interface element for the producer 420. In some instances, the interface elements may be selectable in order to view information associated with the various users and/or information input into the system by the various users. For instance, and in the example of FIG. 4, the user may select the sixth interface element for the mill 418, which is illustrated by the hand selecting the sixth interface element. In response, and as shown by the right illustration of the electronic device 402, the electronic device 402 may provide additional information 422 associated with the mill 418.

In some instances, the information 422 may include at least some of the information 140 from the example of FIG. 1. For example, the information 422 may include, but is not limited to, the weight 114, the factor 116, the quantity 122, the price 124, and/or the total price 126. This way, each of the users included in the supply chain are able to use the ledger in order to view the information that was input by the mill.

As further illustrated in the example of FIG. 4, the user interface 404 includes dates located next to each of the different types of users. In some instances, the dates may indicate the times at which the different types of users received the shipment 102 and/or the times at which the different types of users input information into the system. This way, each of the users is able to use the supply chain ledger 406 to track the shipment 102 from the producer 104 all the way to the customer.

It should be noted that, while the example of FIG. 4, illustrates the users as including the café 410, the roaster 412, the importer 414, the exporter 416, the mill 418, and the producer 420, in other examples, the supply chain and/or the ledger may include more or less users. Additionally, although the ledger included in the example of FIG. 4 is for a shipment of coffee beans, in other examples, the ledger may be for shipments of other types of products. In such examples, the users included in the ledger may differ from the users illustrated in the example of FIG. 4.

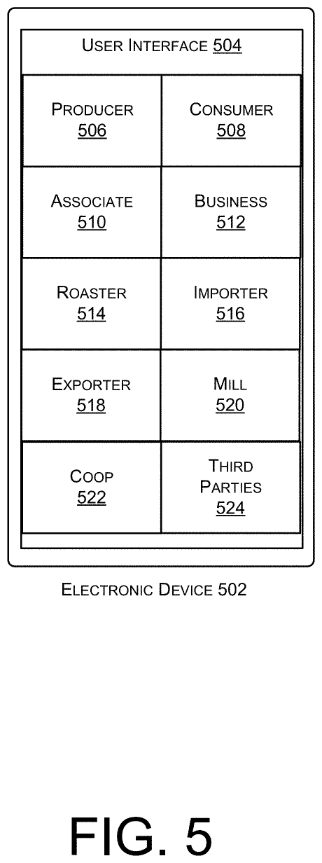

FIG. 5 illustrates an example user interface for selecting users associated with the supply chain for the shipment 102 of FIG. 1. As shown, an electronic device 502 (which may represent, and/or include, the electronic device 108, the electronic device 134, the electronic device 402, and/or another electronic device) is providing a user interface 504 for selecting a type of user associated with the supply chain. For instance, and as shown, the user interface 504 includes a first interface element for selecting a producer 506, a second interface element for selecting a consumer 508, a third interface element for selecting an associate 510 (e.g., a barista), a fourth interface element for selecting a business 512 (e.g., café, brand, etc.), a fifth interface element for selecting a roaster 514, a sixth interface element for selecting an importer 516, a seventh interface element for selecting an exporter 518, an eighth interface element for selecting a mill 520, a ninth interface element for selecting a cooperation 522, and a tenth interface element for selecting third-parties 524.

In some instances, a user of the electronic device 502 may select the interface element that represents the type of user that is using the electronic device 502. For a first example, if the producer 104 is using the electronic device 502, then the producer 104 may select the first interface element associated with the producer 506. In response, the electronic device 502 may allow the producer 104 to create an account if the producer 104 has yet to create an account. However, if the producer 104 has already created the account, then the electronic device 502 may bring the producer 104 to the created account. For instance, the electronic device 502 may provide the producer 104 with at least the user interface 302 for managing orders.

For a second example, if the user 106 is using the electronic device 502, then the user 106 may select the eighth interface element associated with the mill 520. In response, the electronic device 502 may allow the user 106 to create an account if user 106 has yet to create an account. However, if the user 106 has already created the account, then the electronic device 502 may bring the user 106 to the created account. For instance, the electronic device 502 may provide the user 106 with at least the user interface 112 for creating a new shipment that is occurring at the mill.

It should be noted that, while the example of FIG. 5 illustrates the user interface 504 as including ten interface elements for selecting between ten different types of users, in other examples, the user interface 504 may include more or less interface elements. Additionally, in some instances, the user interface 504 may include interface elements that are associated with additional types of users.

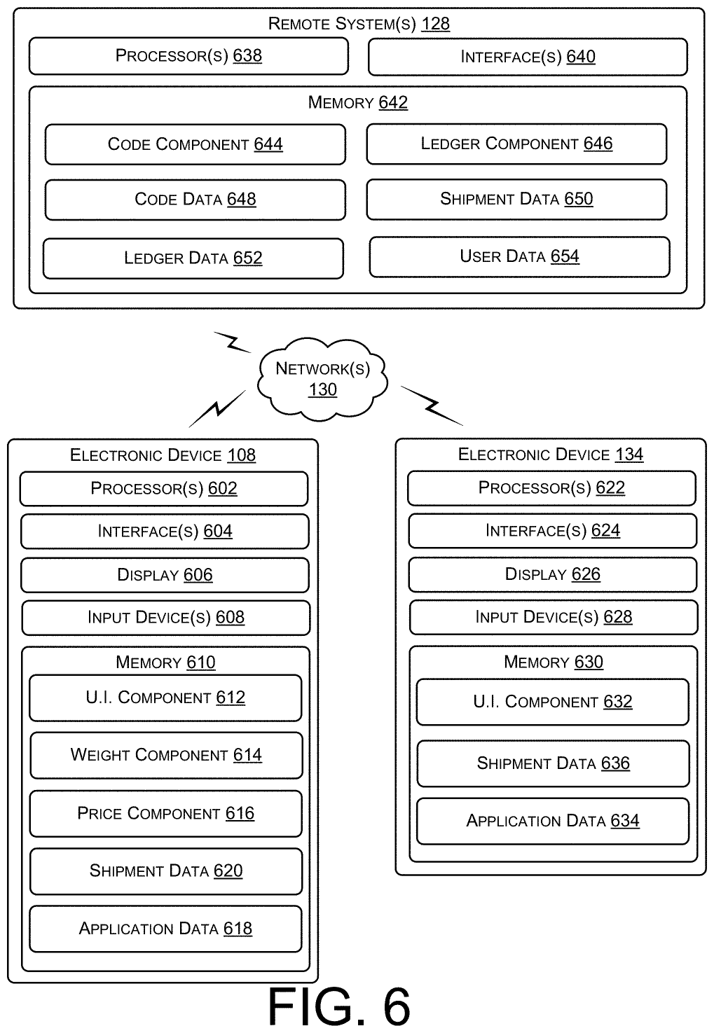

FIG. 6 illustrates an example environment that includes various devices communicating in order to provide information associated with the shipment 102 from FIG. 1. As shown, the environment includes the electronic device 108, the remote system(s) 128, and the electronic device 134. However, in other examples, the environment may include one or more additional devices. For example, the environment may include one or more additional devices associated with various types of users that are included in the supply chain.

As shown, the electronic device 108 may include processor(s) 602, network interface(s) 604, a display 606, input device(s) 608, and memory 610. The memory 610 may store various components of the electronic device 108, such as a user interface component 612, a weight component 614, and a price component 616. The user interface component 612 may be configured to generate and update the user interfaces provided by a shipment application, where the shipment application may be represented by application data 618. For instance, the user interface component 612 may be configured to generate and/or update the user interface 112, the user interface 404, and/or the user interface 504. The shipment application may provide the electronic device 108 with all the functionality described herein.

For example, and using the example of FIG. 1, such as when the user 106 is inputting information associated with the shipment 102, the user interface component 612 may cause the electronic device 108 to provide the user interface 112. The user interface component 612 may then allow the user to input information into the user interface 112 and update the user interface 612 with the inputted information. Additionally, the user interface component 612 may update the information included in the user interface 112 as the electronic device 108 is performing the calculations described herein to determine additional information associated with the shipment 102, such as the quantity 122, the price 124, and/or the total price 126.

The weight component 614 may be configured to perform the processes described herein to determine weights associated with shipments. For example, and again using the example of FIG. 1, the weight component 614 may be configured to use at least the weight 114 and the factor 116 inputted by the user 106 to determine the quantity 122. In some instances, the weight component 614 determines the quantity 122 by multiplying the weight 114 by the factor 116. After the weight component 614 determines the quantity 122, the user interface component 612 may be configured to update the user interface 112 to include the quantity 122.

The price component 616 may be configured to perform the processes described herein to determine prices associated with shipments. For example, and again using the example of FIG. 1, the price component 616 may be configured to use at least the quantity 122 and the price 124 to determine the total price 126 for the producer 104. In some instances, the price component 616 determines the total price 126 by multiplying the quantity 122 by the price 124. After the price component 616 determines the total price 126, the user interface component 612 may be configured to update the user interface 112 to include the total price 126.

As further illustrated in the example of FIG. 6, the electronic device 108 may store shipment data 620. The shipment data 620 may represent data input by one or more users included in supply chains associated with shipments. For example, the shipment data 620 may represent the data input into the electronic device 108 and/or the electronic device 134 for the shipment 102. In some instances, the electronic device 108 generates and then sends at least a portion of the shipment data 620 in response to the user 106 selecting the interface element associated with sending data 132. In some instances, the electronic device 108 receives at least a portion of the shipment data 620 from one or more other devices, such as the remote system(s) 128 and/or the electronic device 134.

Additionally, the electronic device 134 may include processor(s) 622, network interface(s) 624, a display 626 input device(s) 628, and memory 630. The memory 630 may store various components of the electronic device 134, such as a user interface component 632. The user interface component 632 may be configured to generate and update the user interfaces provided by a shipment application, where the shipment application may be represented by application data 634. For instance, the user interface component 632 may be configured to generate and/or update the user interface 138, the user interface 302, the user interface 318, the user interface 404, and/or the user interface 504. The shipment application may provide the electronic device 134 with all the functionality described herein.

For example, and again using the example of FIG. 1, after the electronic device 134 receives shipment data 636 representing the shipment 102, the user interface component 632 may cause the electronic device 134 to provide the user interface 138. The user interface component 632 may then allow the producer 104 to input whether the information 140 is approved 142 or disapproved 144. After receiving the input, the electronic device 134 may be configured to generate shipment data 636 representing whether the information 140 is approved 142 or disapproved 144 and send the shipment data 636 to one or more devices, such as the remote system(s) 128 and/or the electronic device 108.

As further illustrated in the example of FIG. 6, the electronic device 108 may store the shipment data 636 (which may be similar to, or different from, the shipment data 620). The shipment data 636 may represent data input by one or more users included in supply chains associated with shipments. For example, and as discussed above, the shipment data 636 may represent the data input into the electronic device 108 and/or the electronic device 134 for the shipment 102. In some instances, the electronic device 134 generates and then sends at least a portion of the shipment data 636 in response to the producer 104 inputting information associated with the shipment 102. In some instances, the electronic device 134 receives at least a portion of the shipment data 636 from one or more other devices, such as the remote system(s) 128 and/or the electronic device 108.

Furthermore, in the example of FIG. 6, the remote system(s) 128 may include processor(s) 638, network interface(s) 640, and memory 642. The memory 642 may store various components of the remote system(s) 128, such as code component 644 and a ledger component 646. The code component 644 may be configured to generate codes, such as QR codes, that are used to track shipments, where the codes are represented by code data 626. For example, and again using the example of FIG. 1, the code component 644 may generate a code that is used to track the shipment 102 from the producer 104 all the way to the consumer. In some instances, the remote system(s) 128 may use the codes to determine which shipment data 650 to send to devices that are requesting data associated with a shipment.

For example, and again using the example of FIG. 1, the electronic device 134 may be requesting data associated with the shipment 102. As such, the remote system(s) 128 may receive, from the electronic device 134, code data 648 representing the code for the shipment 102. The remote system(s) 128 may then use the code data 648 to identify that the electronic device 134 is requesting the shipment data 650 for the shipment 102. In response, the remote system(s) 128 may send the identified shipment data 650 to the electronic device 134. This way, the remote system(s) 128 allow all users that are included in the supply chain to request the shipment data 650 for that particular shipment 102.

The ledger component 646 may be configured to generate ledgers for shipments, where the ledgers may be represented by ledger data 652. In some instances, the ledgers may include blockchain ledgers. By generating a ledger for a shipment, the remote system(s) 128 may ensure that each user participating within the supply chain is able to maintain a full record of the shipment. To create a ledger, the ledger component 646 may initially determine if a shipment incudes a new shipment for which a ledger needs to be generated or if the shipment does not include a new shipment such that the ledger has already been created for the shipment. In some instances, the ledger component 646 makes the determination using the code associated with the shipment. For instance, the ledger component 646 may determine if the code for the shipment matches a code for a ledger and, if there is a match, the ledger component 646 may determine that there is already a ledger for the shipment.

To create the ledger, the ledger component 646 may initially authorize users that are included in the supply chain. In some instances, the ledger component 646 may authorize a user based on receiving the code associated with the supply chain for the shipment. However, in other instances, the ledger component 646 may authorize the user using other types of information, such as an identifier (e.g., name), address, password, and/or the like associated with the supply chain. Once the user has been authorized, the ledger component 646 may determine the capacity that the user is authorized to participate in the ledger. For instance, users may be permitted to read the ledger, add to the ledger, and/or both read and add to the ledger.

The leger component 646 may then use shipment data 650 associated with the shipment to add data to the ledger. For example, if the remote system(s) 128 receive shipment data 650 from the electronic device 108 for a shipment, then the ledger component 646 may add at least a portion of the shipment data 650 to the ledger for the shipment. Next, if the remote system(s) 128 receive shipment data 650 from the electronic device 134 for the shipment, again the leger component 646 may add at least a portion of the shipment data 650 to the ledger. The ledger component 646 may continue to receive shipment data 650 from other users included in the supply chain and add at least a portion of the shipment data 650 to the ledger. This way, as the shipment advances through the supply chain, the ledger component 646 is able to update the ledger for the shipment such that all of the users included in the supply chain are able to view the ledger to determine how the shipment is proceeding and/or information about the shipment.

As further illustrated in the example of FIG. 6, the remote system(s) 128 may store user data 654. The remote system(s) 128 may use the user data 654 to provide traceability associated with supply chains. For example, the user data 654 for a given user may represent at least an identifier of the user (e.g., name, username, identity, etc.), contact information associated with the user (e.g., phone number, email address, etc.), a location associated with the user (e.g., the address, region, county, state, country etc.), and/or other information associated with the user. For example, if the user includes a farmer, then the user data 654 may represent the identity of the farmer, the location of the farmer, the variety of the product associated with the farmer, the process that the farmer uses, and/or any other information associated with the farmer.

In some instances, the remote system(s) 128 may provide at least a portion of the user data 654 to each of the users included in the supply chain for a product. The users may then use their respective electronic device, which are illustrated herein, to review at least a portion of the information that is associated with one or more other users included in the supply chain. For example, the other users included in the supply chain may receive user data 654 associated with the farmer. The other users may then use the user data 654 in order to determine the information that is associated with the farmer.

In some instances, the remote system(s) 128 provide the users within a supply chain with self-sovereign identities (SSIs) so that the users are able to create and control their own credentials (e.g., the information described herein), where the SSIs may also be represented by the user data 654. For example, the SSI associated with a user, such as a farmer, may be associated with all of the information associated with the farmer, which is described herein. Although the example of FIG. 6 illustrates the user data 654 as being stored by the remote system(s) 128, in other examples, one or more other devices may store the user data 654. For example, the electronic device 134 associated with the producer 104 (e.g., the farmer) may store the user data 654 that represents the SSI for the producer 104.

As used herein, a processor, such as the processor(s) 602, the processor(s) 622, and/or the processor(s) 638, may include multiple processors and/or a processor having multiple cores. Further, the processors may comprise one or more cores of different types. For example, the processors may include application processor units, graphic processing units, and so forth. In one instance, the processor may comprise a microcontroller and/or a microprocessor. The processor(s) may include a graphics processing unit (GPU), a microprocessor, a digital signal processor or other processing units or components known in the art. Alternatively, or in addition, the functionally described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) may possess its own local memory, which also may store program components, program data, and/or one or more systems.

Memory, such as the memory 610, the memory 630, and/or the memory 642, may include volatile and nonvolatile memory, removable and non-removable media implemented in any method or technology for storage of information, such as computer-readable instructions, data structures, program component, or other data. The memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computing device. The memory may be implemented as computer-readable storage media (“CRSM”), which may be any available physical media accessible by the processor(s) to execute instructions stored on the memory. In one basic instance, CRSM may include random access memory (“RAM”) and Flash memory. In other instances, CRSM may include, but is not limited to, read-only memory (“ROM”), electrically erasable programmable read-only memory (“EEPROM”), or any other tangible medium which can be used to store the desired information and which can be accessed by the processor(s).

Further, functional components may be stored in the respective memories, or the same functionality may alternatively be implemented in hardware, firmware, application specific integrated circuits, field programmable gate arrays, or as a system on a chip (SoC). In addition, while not illustrated, each respective memory discussed herein may include at least one operating system (OS) component that is configured to manage hardware resource devices such as the network interface(s), the I/O devices of the respective apparatuses, and so forth, and provide various services to applications or components executing on the processors. Such OS component may implement a variant of the FreeBSD operating system as promulgated by the FreeBSD Project; other UNIX or UNIX-like variants; a variation of the Linux operating system as promulgated by Linus Torvalds; the FireOS operating system from Amazon.com Inc. of Seattle, Wash., USA; the Windows operating system from Microsoft Corporation of Redmond, Wash., USA; LynxOS as promulgated by Lynx Software Technologies, Inc. of San Jose, Calif.; Operating System Embedded (Enea OSE) as promulgated by ENEA AB of Sweden; and so forth.

Network interface(s), such as the network interface(s) 604, the network interface(s) 624, and/or the network interface(s) 640, may enable data to be sent between devices. For example, the network interface(s) may enable data to be sent between the electronic device 108, the electronic device 134, the remote system(s) 128, and/or with one or more other remote systems, as well as other networked devices. The network interface(s) may include one or more network interface controllers (NICs) or other types of transceiver devices to send and receive messages over the network(s) 130.

For instance, each of the network interface(s) may include a personal area network (PAN) component to enable messages over one or more short-range wireless message channels. For instance, the PAN component may enable messages compliant with at least one of the following standards IEEE 802.15.4 (ZigBee), IEEE 802.15.1 (Bluetooth), IEEE 802.11 (WiFi), or any other PAN message protocol. Furthermore, each of the network interface(s) may include a wide area network (WAN) component to enable message over a wide area network.

Input device(s), such as the input device(s) 608 and/or the input device(s) 628, may include any device that allows a user to provide input to an electronic device. For instance, input device(s) may include, but are not limited to, a touch-sensitive display, a keyboard, a joystick, a mouse, and/or any other type of input device. Additionally, a display, such as the display 606 and/or the display 624, may include any type of display.

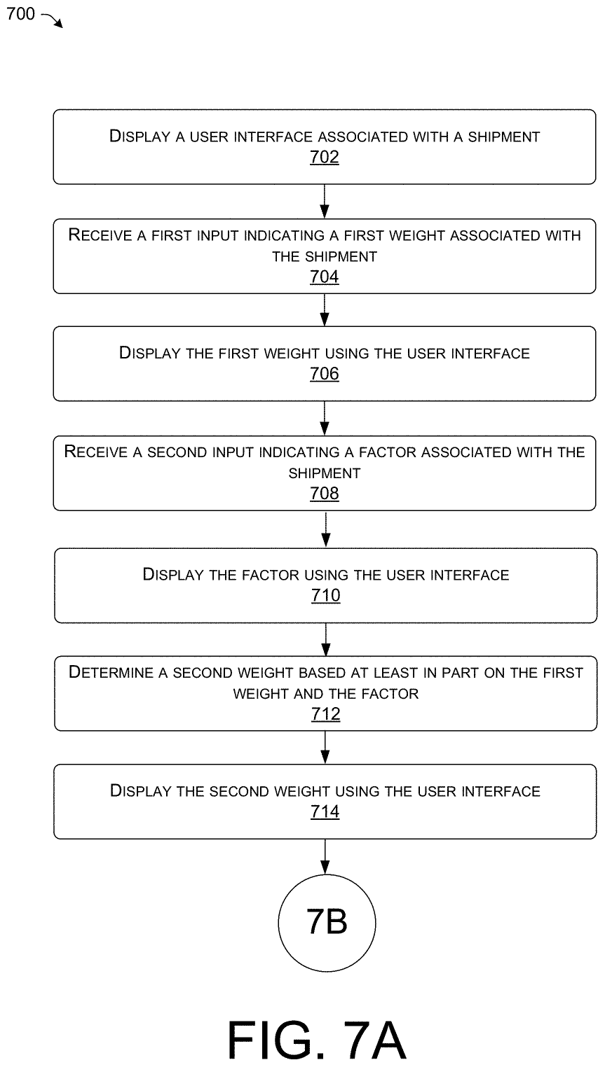

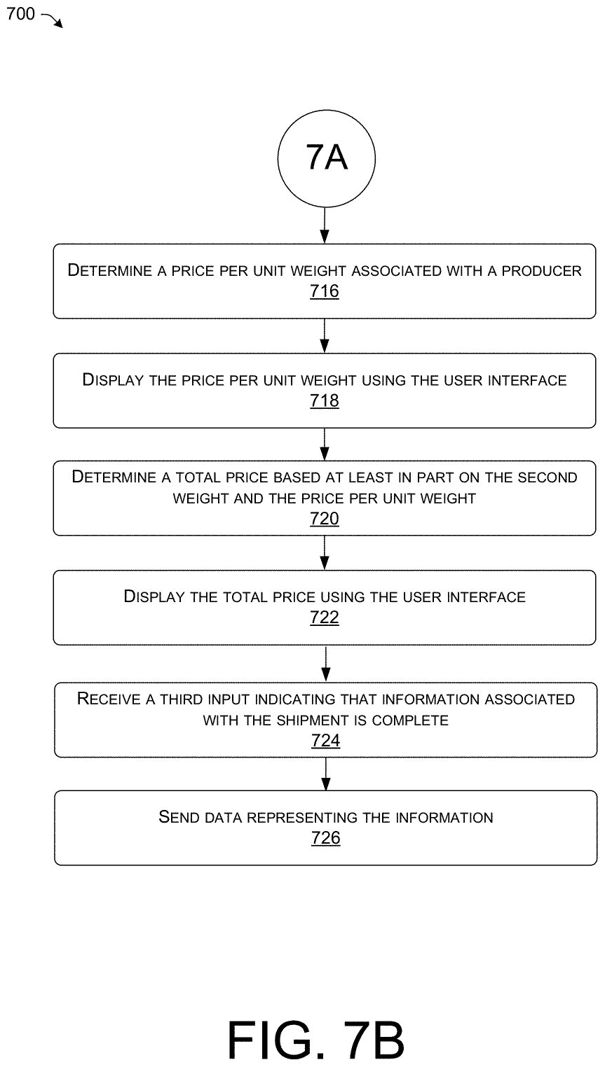

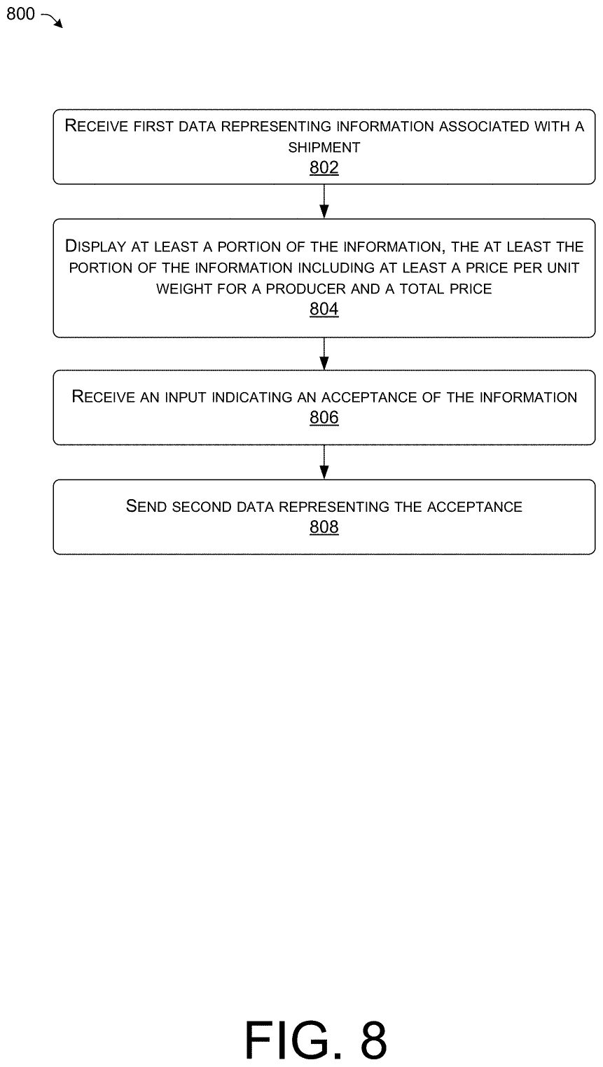

FIGS. 7A-8 illustrate various processes for implementing the techniques described herein. The processes described herein are illustrated as collections of blocks in logical flow diagrams, which represent a sequence of operations, some or all of which may be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed.

FIGS. 7A-7B are an example process 700 for inputting information associated with a shipment into an electronic device. At 702, the process 700 may include displaying a user interface associated with a shipment. For instance, an electronic device may display the user interface that is associated with inputting information associated with a shipment. In some instances, the electronic device is associated with a mill and the shipment includes a shipment for coffee beans. However, in other examples, the electronic device may be associated with a different type of user included in the supply chain and/or the shipment may be for other types of products.

At 704, the process 700 may include receiving a first input indicating a first weight associated with the shipment and at 706, the process 700 may include displaying the first weight using the user interface. For instance, the electronic device may receive the first input from the user. In some instances, the first weight is associated with a gross weight for the shipment. The electronic device may then update an interface element of the user interface to indicate the first weight. In some instances, the first weight may be shown in pounds. However, in other instances, the first weight may be shown using a different type of unit of measurement, such as grams.

At 708, the process 700 may include receiving a second input indicating a factor associated with the shipment and at 710, the process 700 may include displaying the factor using the user interface. For instance, the electronic device may receive the second input from the user. In some instances, the factor may include a percentage, a ratio, and/or the like associated with the shipment. For example, if the shipment includes a shipment of coffee beans, the factor may be for determining the green weight associated with the shipment. The electronic device may then update an interface element of the user interface to indicate the factor.

At 712, the process 700 may include determining a second weight based at least in part on the first weight and the factor and at 714, the process 700 may include displaying the second weight using the user interface. For instance, the electronic device may determine the second weight using the first weight and the factor. As discussed above, the second weight may include the green weight associated with the shipment. For instance, the second weight may be determined by multiplying the gross weight by the factor. The electronic device may then update an interface element of the user interface to indicate the second weight.

At 716, the process 700 may include determining a price per unit weight associated with a producer and at 718, the process 700 may include displaying the price per unit weight using the user interface. For instance, the electronic device may determine the price per unit weight. In some instances, the electronic device determines the price per unit weight by receiving, from one or more devices, data representing the price per unit weight. In some instances, the electronic device determines the price per unit weight by receiving, from the user, an input indicating the price per unit weight. In either instance, the electronic device may then update an interface element of the user interface to indicate the price per unit weight for the producer.

At 720, the process 700 may include determining a total price based at least in part on the second weight and the price per unit weight and at 722, the process 700 may include displaying the total price using the user interface. For instance, the electronic device may determine the total price using the second weight and the price per unit weight. In some instances, the electronic device determines the total price by multiplying the second weight by the price per unit weight. The electronic device may then update an interface element of the user interface to indicate the total price.

At 724, the process 700 may include receiving a third input indicating that information associated with the shipment is complete and at 726, the process 700 may include sending data representing the information. For instance, the electronic device may receive the input indicating that the information for this portion of the shipment is complete. In some instances, the input corresponds to a selection of an interface element of the user interface. The electronic device may then generate and send, to one or more devices, data representing the information. In some instances, the data is then shared with one or more other users included in the supply chain. Additionally, or alternatively, in some instances, the data is added to a ledger associated with the shipment.

FIG. 8 is an example process 800 for approving information associated with a shipment. At 802, the process 800 may include receiving first data representing information associated with a shipment and at 804, the process may include displaying at least a portion of the information, the at least the portion of the information including at least a price per unit weight for a producer and a total price. For instance, an electronic device may receive the first data from one or more devices. The electronic device may then display the at least the portion of the information using a user interface. The at least the portion of the information may include, but is not limited to, the gross weight, the factor, the green weight, the price per unit weight, and/or the total weight.

At 806, the process 800 may include receiving an input indicating an acceptance of the information and at 808, the process 800 may include sending second data representing the acceptance. For instance, the electronic device may receive, from a user, the input indicating the acceptance. In some instances, receiving the input includes receiving a selection of an interface element of the user interface, where the interface element is associated with accepting the information. Based on the acceptance, the electronic device may generate and then send, to one or more devices, the data representing the acceptance.

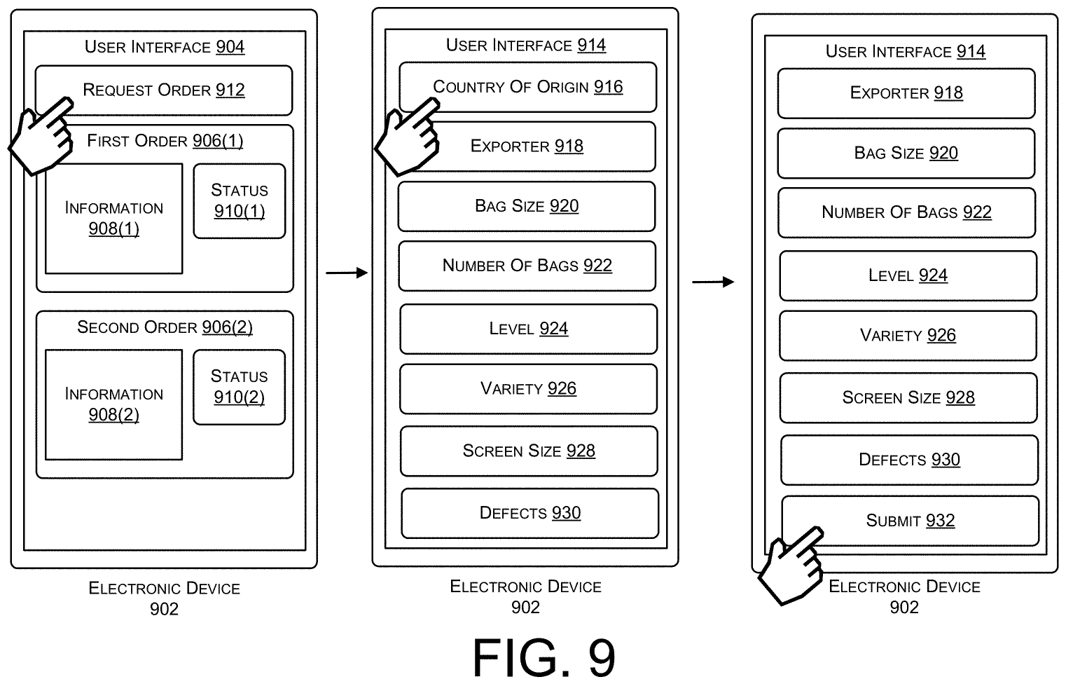

FIG. 9 illustrates an example of an importer creating an offer that is to be fulfilled by at least one exporter. As shown, an electronic device 902 may initially display a user interface 904 for viewing and/or creating orders. As shown, the user interface 902 includes a first interface element associated with a first order 906(1) and a second interface element associated with a second order 906(2). The first interface element includes information 908(1) associated with the first order 906(1) and an indication that the first order 906(1) includes a status 910(1) of the order (e.g., new order, waiting order, pending order, etc.). The second interface element includes information 908(2) associated with the second order 906(2) and an indication that the second order 906(2) includes a status 910(2) of the order (e.g., new order, waiting order, pending order, etc.). As described herein, the information 908(1)-(2) may include, but is not limited to, a quantity, a number of sacks, an importer fee, and/or any other type of information associated with an order. In some instances, the user may select the first interface element to edit, view, and/or delete the first order 906(1) and/or select the second interface element to edit, view, and/or delete the second order 906(2).

The user interface 904 also includes a third interface element for requesting a new order 912. For example, when the user selects the third interface element, which is shown by the left illustration of the user interface 902, the electronic device 902 may provide a user interface 914 (which may be the same as, or different than, the user interface 904) for providing information for an offer for the new order. As shown, the user interface 914 includes interface elements for inputting the country of origin 916 for the offer, the selected exporter 918 for the offer, the bag size 920, the number of bags 922, the level 924, the variety 926 of the product, the screen size 928 for the product, and any defects 930 associated with the product. For example, and as shown by the middle illustration of the electronic device 902, the user may select the interface elements in order to input the requested information. While these are just a couple examples of information that may be input for the new offer, in other examples, the user interface 914 may allow the user to input additional and/or alternative information.

As further illustrated in the example of FIG. 9, the user interface 914 may also include a fourth interface element for submitting 932 the offer. For example, and as shown by the right illustration of the electronic device 902, the user may select the fourth interface element. This may cause the electronic device 902 to send data (which may be represented by the shipment data 650) for the offer to the remote system(s) 128, where the data represents at least the inputted information.

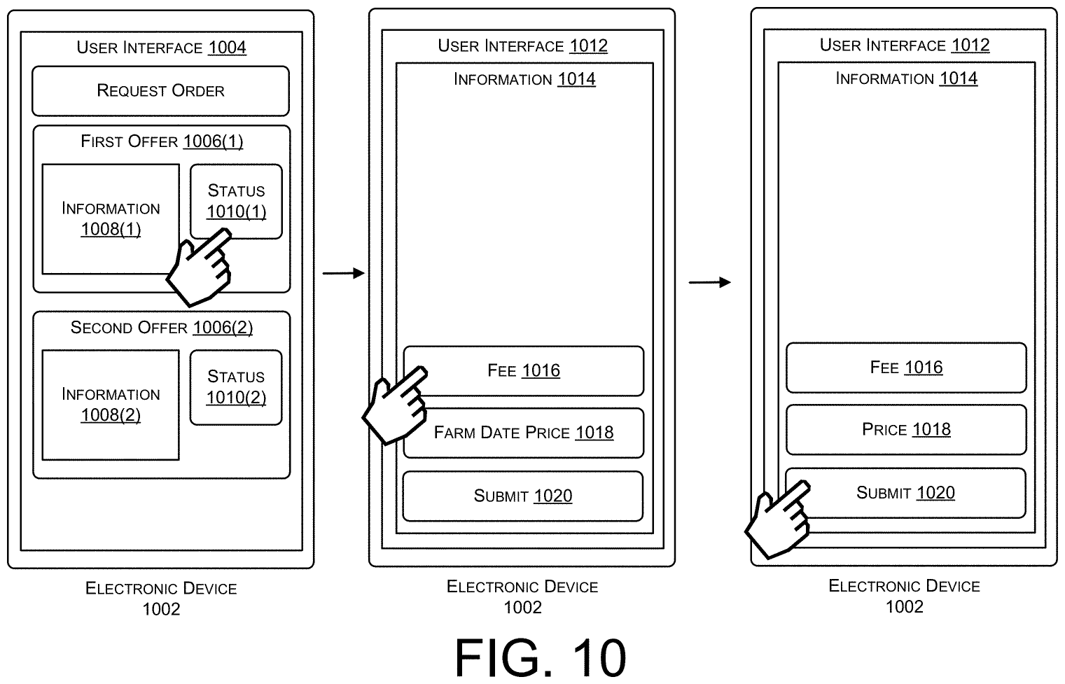

FIG. 10 illustrates an example of an exporter accepting the offer from the example of FIG. 9. For instance, an electronic device 1002 may receive, from the remote system(s) 128, the data representing the offer. As shown, an electronic device 1002 may then initially display a user interface 1004 for viewing and/or accepting offers. As shown, the user interface 1002 includes a first interface element associated with a first offer 1006(1), which may include the offer submitted in the example of FIG. 9, and a second interface element associated with a second offer 1006(2). The first interface element includes information 1008(1) associated with the first offer 1006(1) and a status 1010(1) for the first offer 1006(1) (e.g., waiting). The second interface element includes information 1008(2) associated with the second offer 1006(2) and a status 1010(2) for the second offer 1006(2) (e.g., waiting). As described herein, the information 1008(1)-(2) may include, but is not limited to, an offer date, a name of the importer, a contact name for the importer, contact information (e.g., an address, email address, phone number, etc.) for the importer, and/or any other type of information associated with an offer. In the example of FIG. 10, and as shown by the left illustration of the electronic device 1002, the user may select to view the first offer 1006(1).

Next, and as shown by the middle illustration of the electronic device 1002, the electronic device 1002 may provide a user interface 1012 (which may be the same as, or different than, the user interface 1004) that includes information 1014 associated with the first offer 1006(1). The information 1014 may include, but is not limited to, the offer date, the country of origin, the bag size, the bags, the quantity, the level, the variety, the process, the screen size, the defects, and/or any other information (e.g., information input by the importer). The user interface 1014 may further include a third interface element for inputting the fee 1016 associated with the exporter, which is selected by the user. After inputting the fee 1016, the user interface 1014 may include a fourth interface element that automatically updates a price 1018, such as a farm day price, for the offer. For example, the electronic device 1002 may use the fee 1016, as well as any other costs associated with exporting the offer, to determine the price 1018 and update the user interface 1014.

As further shown by the right illustration of the electronic device 1002, the user interface 1016 includes a fifth interface element to submit 1020 at least the price 1018 for the offer back to the importer. For instance, when the user selects the fifth interface element, the electronic device 1002 may send, to the remote system(s) 128, data (which may also be represented by the shipment data 650) representing at least the price.

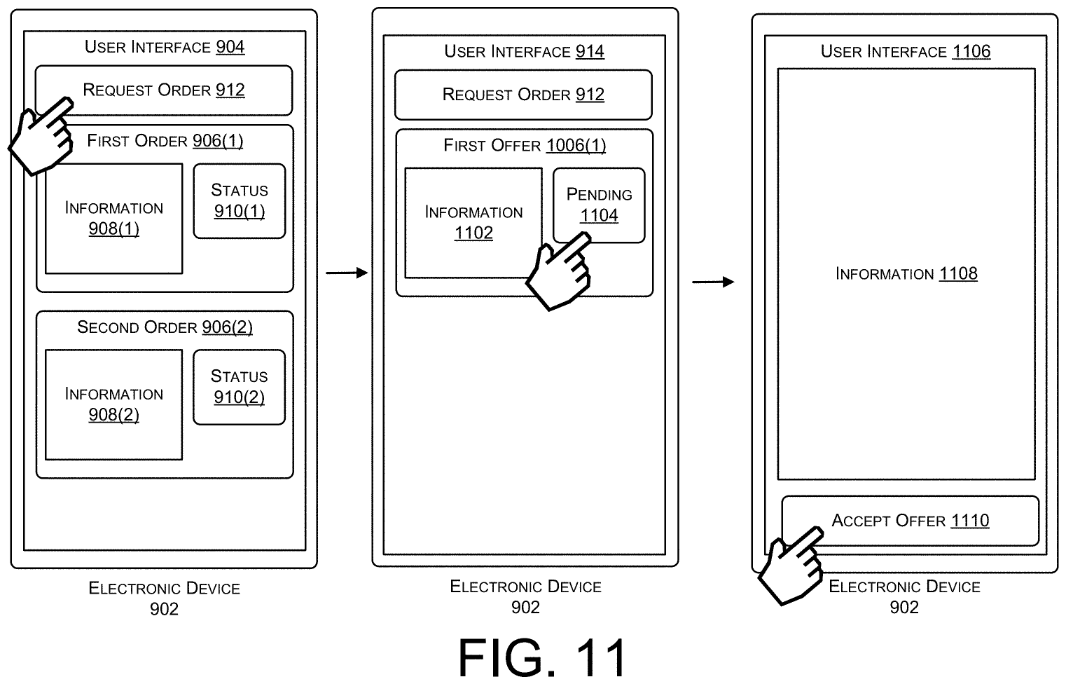

FIG. 11 illustrates an example of the importer now accepting the offer from the example of FIG. 9. For example, the electronic device 902 may receive, from the remote system(s) 128, the data for the offer. As shown by the left illustration of the electronic device 902, the electronic device 902 may then receive a selection of the requested orders 912. In response, and as shown in the middle illustration of the electronic device 902, the electronic device 902 may now provide the user interface 914 that now includes an interface element for the first offer 1006(1). As shown, the interface element may include information 1102 associated with the first offer 1006(1) and an indication that the first offer 1006(1) is pending 1104 approval by the importer. The information 1102 may include, but is not limited to, the country of origin, the bag size, the number of bags, the level, and/or any other type of information associated with the first offer 1006(1).

In the example of FIG. 11, and as shown by the middle illustration of the electronic device 902, the electronic device 902 may receive an input selecting the first offer 1006(1). In response, and as illustrated by the right illustration of the electronic device 902, the electronic device 902 may provide a user interface 1106 (which may be the same as, or different than, the user interface 904 and/or the user interface 914) that includes information 1108 associated with the first offer 1006(1). The information 1108 may include, but is not limited to, all of the information input by the importer as well as the fee 1016, the price 1018, and the total exporter fee. The electronic device 902 may then receive, using an interface element of the user interface 1106, an input indicating an acceptance 1110 of the first offer 1006(1). In response, the electronic device 1110 may send, to the remote system(s) 128, data (which may also be represented by the shipment data 650) indicating that the first offer 1006(1) was accepted.

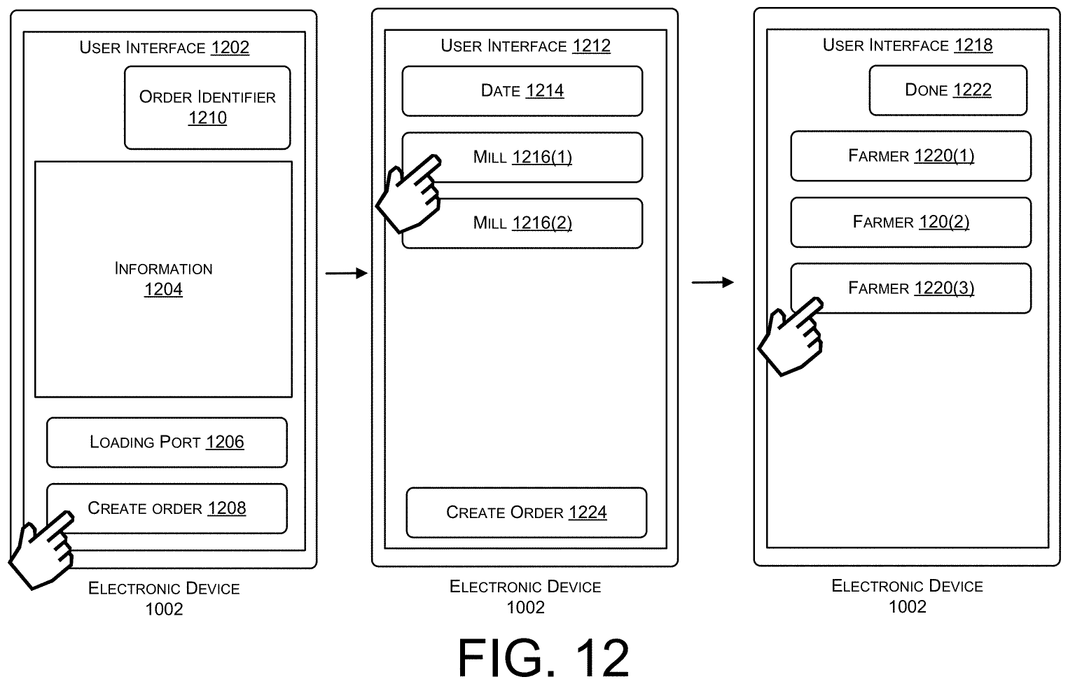

FIG. 12 illustrates an example of the exporter creating an order for the accepted offer from FIGS. 9-11. As shown by the left illustration of the electronic device 1002, the electronic device 1004 may provide a user interface 1202 that includes information 1204 for the accepted offer 1006(1). The user interface 1202 further an interface element for inputting a loading port 1206 to fulfill the order associated with the offer. For example, the electronic device 1002 may receive, via the interface element, an input indicating the loading port 1206. After inputting the loading port 1206, the electronic device 1002 may receive, using another interface element, an input associated with creating the order 1208 for the offer.

As further illustrated in the example of FIG. 12, the user interface 1202 includes an interface element that includes the identifier 1210 for the order, which is described above. For example, when the electronic device 1002 receives an input selecting the identifier 1210, the electronic device 1002 may display the supply chain ledger 406 associated with the order. As described above, other users included in the supply chain are also able to view the supply chain ledger 406, which is updated as the product moves through the supply chain.

After receiving the input selecting to create order 1208, the electronic device 1002 may provide a user interface 1212 (which may be the same as, or different than, the user interface 1202) for finishing creating the order. For example, and as shown in the middle illustration of the electronic device 1002, the user interface 1212 includes a first interface element for inputting a date 1214 for delivering the product by the farmer(s). The user interface 1212 further includes a second interface element for selecting a first mill 1216(1) for the delivery of the product and a third interface element for selecting a second mill 1216(2) for delivery of the product. In the example of FIG. 12, the electronic device 1002 may receive an input selecting the first mill 1216(1).

Based on the input, and as shown by the right illustration of the electronic device 1002, the electronic device 1002 may provide a user interface 1218 (which may be the same as, or different than, the user interface 1202 and/or the user interface 1212) for selecting a farmer (and/or similarly a coops, which represent multiple farmers). For instance, the user interface 1218 includes a first interface element for selecting a first farmer 1220(1) for fulfilling the order, a second interface element for selecting a second farmer 1220(2) for fulfilling the order, and a third interface element for selecting a third farmer 1220(3) for fulfilling the order. In some instances, the user may select one farmer while in other examples, the user may select more than one farmer. In the example of FIG. 12, the electronic device 1002 may receive a selection of the third interface element associated with the third farmer 1220(3) for fulfilling the order.

Next, the electronic device 1002 may receive an input selecting a fourth interface element indicating that the user is done 1222 selecting farmer(s). In response, the electronic device 1002 may again provide the user interface 1212. While providing the user interface 1212, the electronic device 1002 may receive an input selecting an interface element to create the order 1224. The electronic device 1002 may then send, to the remote system(s) 128, data (which may be represented by the shipment data 650) representing the order. For example, the data may represent the date, the mill, and the selected farmer(s). This data for the order may then be sent by the remote system(s) 128 to the selected farmer(s).

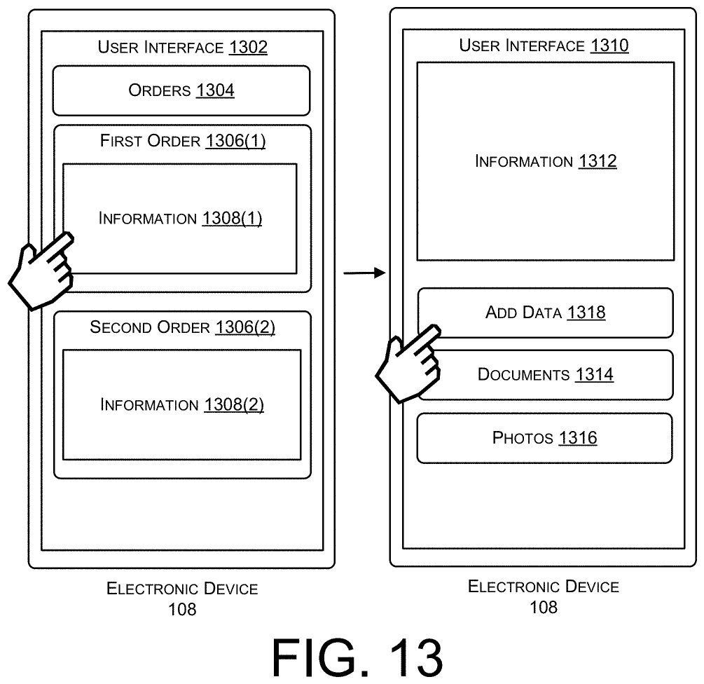

FIG. 13 illustrates an example of the mill viewing the order from FIG. 12 before inputting the necessary information. As shown by the left illustration of the electronic device 108, the electronic device 108 may initially provide a user interface 1302 that includes orders 1304 associated with the mill. For example, the user interface 1302 includes a first interface element associated with a first order 1306(1), which may include the order created in the example of FIG. 12, and a second interface element associated with a second order 1306(2). The user interface 1302 also includes information 1308(1) associated with the first order 1306(1) and information 1308(2) associated with the second order 1306(2). The information 1308(1)-(2) may include, but is not limited to, the weight, the base percentage, the delivery date, the identifier of the exporter, the required weight, and/or any information associated with the order.

It the example of FIG. 13, the electronic device 108 may receive an input selecting the first interface element associated with the first order 1306(1). Based on the input, the electronic device 108 may provide a user interface 1310 (which may be the same as, or different than, the user interface 1302) for the first order 1306(1). For example, the user interface 1310 includes additional information 1312 for the first order 1306(1). The information 1312 may include, but is not limited to, the identifier to view the supply chain ledger 406, the weight, the delivery date, the exporter, the number of farmers, the quantity, the number of sacks, and/or any other information.

The user interface 1310 further includes a first interface element for importing documents 1314 associated with the first order 1306(1) and a second interface element for importing photos 1316 of the first order 1306(1). Furthermore, the user interface 1310 includes a third interface element for inputting data 1318 associated with the first order 1306(1). For example, and as shown by the right illustration of the electronic device 108, the electronic device 108 may receive an input selecting the third interface element. Based on the input, the electronic device 108 may provide the user interface 112 from the example of FIG. 2. The farmer is then able to accept the inputted data using the process from the example of FIG. 3.

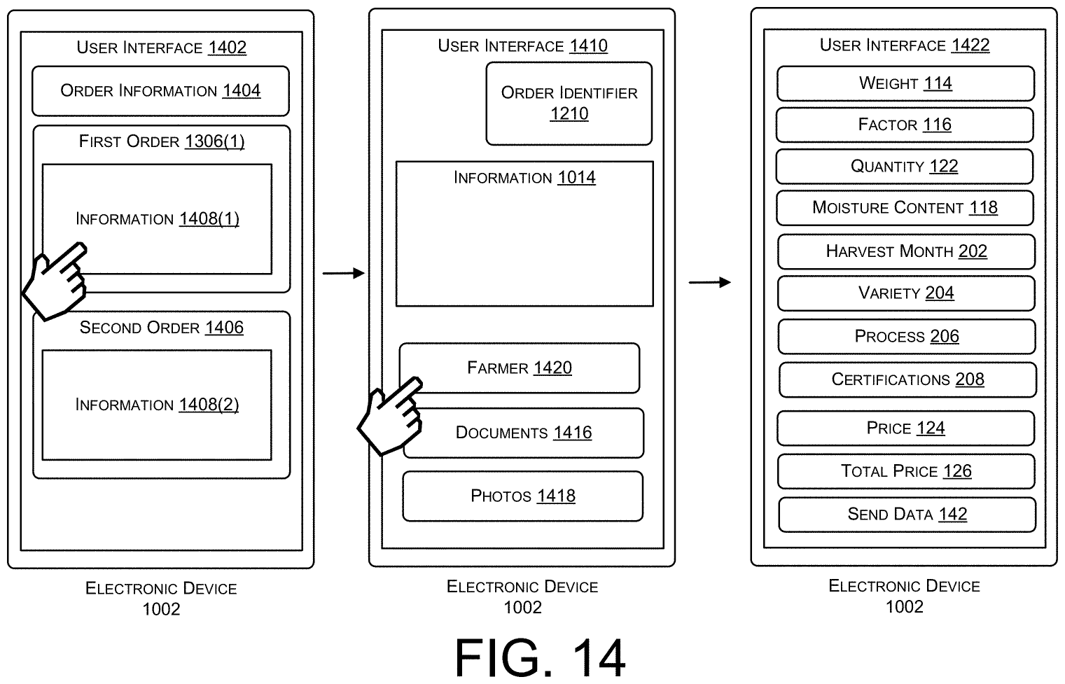

FIG. 14 illustrates an example of the exporter viewing the order after the farmer has accepted the data input by the mill in the example of FIG. 13. As shown by the left illustration of the electronic device 1002, the electronic device 1002 may provide a user interface 1402 for orders. The user interface 1402 may include a first interface element 1404 that includes total order information 1404. The total order information may include, but is not limited to, a total number of orders, a total number of in progress orders, and a total number of completed orders.

While in the in-progress orders, the user interface 1402 further includes a first interface element associated with the first order 1306(1) and a second interface element associated with a second order 1406. The first interface element includes information 1408(1) associated with the first order 1306(1) while the second interface element includes information 1408(2) associated with the second order 1406. The information 1408(1)-(2) may include, but is not limited to, the quantity, the number of sacks, the exporter fee, the exchange rate, the loading date, and/or any other information. In some instances, the information 1408(1)-(2) may also include a status bar indicating whether the order is being processed by the mill, at the mill, and/or shipped by the mill.

In the example of FIG. 14, the electronic device 1002 may receive an input selecting the first interface element associated with the first order 1306(1). In response, and as shown by the middle illustration of the electronic device 1002, the electronic device 1002 may provide a user interface 1410 (which may be the same as, or different than, the user interface 1402) that includes information 1412 about the first order 1306(1). The information 1410 may include, but is not limited to, the number of sacks, the price per quintal, the quantity, the parchment weight, the farm price, the loading date, the exporter free, the exchange rate, the local/farm price, the importer identifier, the country of export, the cup score, the process, the moisture, all the information associated with the farmer (e.g., the data input by the mill), and/or any other information.

The user interface 1410 further includes a first interface element that includes the order identifier 1210. As discussed above, by selecting the order identifier 1210, the electronic device 1002 may provide the supply chain ledger 406. The user interface 1410 also includes a second interface element for importing documents 1416, a third interface element 1418 for importing photos, and a fourth interface element for viewing information associated with the farmer 1420.

For example, if the electronic device 1002 receives an input selecting the fourth interface element, and as shown by the right illustration of the electronic device 1002, the electronic device 1002 may provide a user interface 1422 (which may be the same as, or different than, the user interface 1402 and/or the user interface 1410) that includes all of the information associated with the farmer.

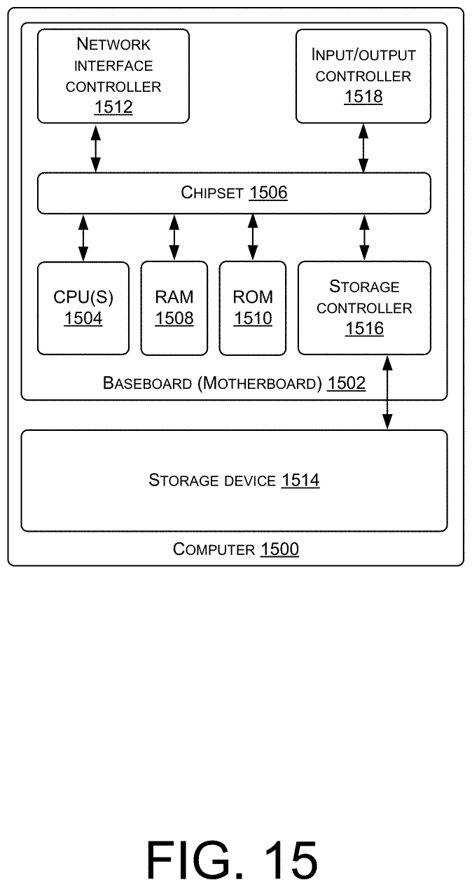

FIG. 15 shows an example computer architecture for a computer 1500 capable of executing program components for implementing the functionality described above. The computer architecture shown in FIG. 15 illustrates a server computer, workstation, desktop computer, laptop, tablet, network appliance, e-reader, smartphone, or other computing device, and may be utilized to execute any of the software components presented herein. In some examples, the computer 1500 may correspond to one or more computing devices that implements the components and/or services described herein (e.g., the electronic device 108, the electronic device 134, the computing system(s) 128, the electronic device 902, and/or the electronic device 1002.).

The computer 1500 includes a baseboard 1502, or “motherboard,” which is a printed circuit board to which a multitude of components or devices may be connected by way of a system bus or other electrical communication paths. In one illustrative configuration, one or more central processing units (“CPUs”) 1504 operate in conjunction with a chipset 1506. The CPUs 1504 may be standard programmable processors that perform arithmetic and logical operations necessary for the operation of the computer 1500.

The CPUs 1504 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, and the like.

The chipset 1506 provides an interface between the CPUs 1504 and the remainder of the components and devices on the baseboard 1502. The chipset 1506 may provide an interface to a random-access memory (RAM) 1508, used as the main memory in the computer 1500. The chipset 1506 may further provide an interface to a computer-readable storage medium such as a read-only memory (“ROM”) 1510 or non-volatile RAM (“NVRAM”) for storing basic routines that help to startup the computer 1500 and to transfer information between the various components and devices. The ROM 1510 or NVRAM may also store other software components necessary for the operation of the computer 1500 in accordance with the configurations described herein.

The computer 1500 may operate in a networked environment using logical connections to remote computing devices and computer systems through a network, such as the LAN 1308. The chipset 1506 may include functionality for providing network connectivity through a network interface controller (NIC) 1512, such as a gigabit Ethernet adapter. The NIC 1512 is capable of connecting the computer 1500 to other computing devices over the LAN 908 (or the network 158). It should be appreciated that multiple NICs 1512 may be present in the computer 1500, connecting the computer to other types of networks and remote computer systems.

The computer 1500 may be connected to a mass storage device 1514 that provides non-volatile storage for the computer 1500. The mass storage device 1514 may store an operating system, programs, and/or components including, without limitation, the certificate service 102 that manages the generating and managing of certificate authorities and/or certificates, as described herein, and data, which have been described in greater detail herein. The mass storage device 1514 may be connected to the computer 1500 through a storage controller 1516 connected to the chipset 1506. The mass storage device 1514 may consist of one or more physical storage units. The storage controller 1516 may interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 1500 may store data on the mass storage device 1514 by transforming the physical state of the physical storage units to reflect the information being stored. The specific transformation of physical state may depend on various factors, in different embodiments of this description. Examples of such factors may include, but are not limited to, the technology used to implement the physical storage units, whether the mass storage device 1514 is characterized as primary or secondary storage, and the like.

For example, the computer 1500 may store information to the mass storage device 1514 by issuing instructions through the storage controller 1516 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 1500 may further read information from the mass storage device 1514 by detecting the physical states or characteristics of one or more particular locations within the physical storage units.

In addition to the mass storage device 1514 described above, the computer 1500 may have access to other computer-readable storage media to store and retrieve information, such as program modules, data structures, or other data. It should be appreciated by those skilled in the art that computer-readable storage media is any available media that provides for the non-transitory storage of data and that may be accessed by the computer 1500.

By way of example, and not limitation, computer-readable storage media may include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that may be used to store the desired information in a non-transitory fashion. The implementation of the various components described herein is a matter of choice dependent on the performance and other requirements of the computing system. Accordingly, the logical operations described herein are referred to variously as operations, structural devices, acts, or modules. These operations, structural devices, acts, and modules may be implemented in software, in firmware, in special purpose digital logic, and any combination thereof.

As mentioned briefly above, the mass storage device 1514 may store an operating system utilized to control the operation of the computer 1500. According to one embodiment, the operating system comprises the LINUX operating system. According to another embodiment, the operating system comprises the WINDOWS® SERVER operating system from MICROSOFT Corporation of Redmond, Wash. According to further embodiments, the operating system may comprise the UNIX operating system or one of its variants. It should be appreciated that other operating systems may also be utilized. The mass storage device 1514 may store other system or application programs and data utilized by the computer 1500.

In one embodiment, the mass storage device 1514 or other computer-readable storage media is encoded with computer-executable instructions which, when loaded into the computer 1500, transform the computer from a general-purpose computing system into a special-purpose computer capable of implementing the embodiments described herein. These computer-executable instructions transform the computer 1500 by specifying how the CPUs 1504 transition between states, as described above. According to one embodiment, the computer 1500 has access to computer-readable storage media storing computer-executable instructions which, when executed by the computer 1500, perform the various processes described above. The computer 1500 may also include computer-readable storage media having instructions stored thereupon for performing any of the other computer-implemented operations described herein.

The computer 1500 may also include one or more input/output controllers 1518 for receiving and processing input from a number of input devices, such as a keyboard, a mouse, a touchpad, a touch screen, an electronic stylus, or other type of input device. Similarly, an input/output controller 1518 may provide output to a display, such as a computer monitor, a flat-panel display, a digital projector, a printer, or other type of output device. It will be appreciated that the computer 1500 might not include all of the components shown in FIG. 15, may include other components that are not explicitly shown in FIG. 15, or might utilize an architecture completely different than that shown in FIG. 15.

Separate instances of these programs can be executed on or distributed across any number of separate computer systems. Thus, although certain steps have been described as being performed by certain devices, software programs, processes, or entities, this need not be the case, and a variety of alternative implementations will be understood by those having ordinary skill in the art.

Additionally, those having ordinary skill in the art readily recognize that the techniques described above can be utilized in a variety of devices, environments, and situations. Although the subject matter has been described in language specific to structural features or methodological acts, it is to be understood that the subject matter defined in the appended claims is not necessarily limited to the specific features or acts described. Rather, the specific features and acts are disclosed as exemplary forms of implementing the claims.

While the foregoing invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

1. An electronic device comprising:
a display;
one or more processors; and
one or more computer-readable media storing instructions that, when executed by the one or more processors, cause the electronic device to perform operations comprising:
causing the display to present a dynamically-generated and customized user interface specific to a user of the electronic device;
receiving, using a first interface element of the user interface, a first input indicating a gross weight associated with a delivery of a commodity;
causing the user interface to present an indication of the gross weight;
receiving, using a second interface element of the user interface, a second input indicating a conversion factor associated with the delivery of the commodity;
causing the user interface to present an indication of the conversion factor;
determining a dynamic green weight associated with the delivery of the commodity based at least in part on the gross weight and the conversion factor;
causing the user interface to present an indication of the virtual green weight;
determining a price per unit weight for a farmer associated with the delivery of the commodity, wherein the price per unit weight is determined based at least in part on (1) dynamically-changing pricing information specific to the geographic location of the electronic device at the time inputs are received, (2) a varietal of the commodity, (3) local currency, (4) quality of commodity, and (5) an identifier of an acquirer;
determining a total price for the farmer based at least in part on the virtual green weight and the price per unit weight, the total price based on a comparison of information estimated prior to delivery by the acquirer and actual weight and quality of the delivery;
causing the user interface to present the total price;
determining that the farmer is associated with a first unique self-sovereign identity indicator, the first unique self-sovereign identity indicator generated by a platform associated with the user interface and configured for secure communication within a supply chain of the delivery of the commodity and data associated with the delivery of the commodity;
determining the farmer is an authorized user of the platform based at least in part on the first unique self-sovereign identity indicator;
identifying the acquirer involved with the supply chain based at least in part on a second unique self-sovereign identity associated with the acquirer;
causing the user interface to display an indication that the farmer and the acquirer are authorized users of the platform;
in response to receiving an indication that the acquirer has acquired the delivery of the commodity, dynamically generating an encrypted Quick Response (QR) code specific to the delivery of the commodity and, when scanned, providing information associated with the delivery of the commodity, geographic location, the acquirer, and the farmer; and
causing the user interface to display the encrypted QR code in association with the delivery.

2. The electronic device as recited in claim 1, the operations further comprising:
receiving, using the user interface, a third input indicating that inputting information associated with the delivery of the commodity is complete, the information including at least one of the gross weight, the virtual green weight, the conversion factor, the price per unit weight, or the total price; and
sending, to one or more computing devices, data representing the information and additional data indicating the farmer, a farm name, and a farm location.

3. The electronic device as recited in claim 2, wherein sending the data to the one or more devices is for acceptance of the information by the farmer.

4. The electronic device as recited in claim 1, wherein determining the price per unit weight for the farmer comprises at least receiving, from one or more devices, data representing the price per unit weight for the farmer.

5. The electronic device as recited in claim 1, the operations further comprising:
receiving, using the user interface, a third input indicating information associated with the delivery of the commodity, the information including at least one of:
a gross weight associated with the delivery of the commodity;
a conversion factor associated with the delivery of the commodity;
a producer associated with the delivery of the commodity;
a geographic region associated with the delivery of the commodity;
a certification(s) associated with the delivery of the commodity;
a harvest month associated with the delivery of the commodity;
a variety associated with the delivery of the commodity; or
a process associated with the delivery of the commodity; and
causing the user interface to present one or more indications of the information.

6. A method of dynamically generating customized user interfaces for display on networked devices, comprising:
determining a location associated with a delivery of a commodity;
determining the local currency exchange rate;
determining a first weight associated with the delivery;
determining a conversion factor associated with the delivery;
determining, based at least in part on the first weight and the conversion factor, a second weight associated with the delivery;
determining a price per unit weight for a producer associated with the delivery, wherein the price per unit weight is determined based at least in part on (1) dynamically-changing pricing information specific to the geographic location of the electronic device at the time inputs are received, (2) a varietal of a commodity associated with the delivery, (3) the local currency exchange rate, (4) quality, and (5) an identifier of an acquirer;
determining a total price for the producer based at least in part on the second weight and the price per unit weight;
generating data representing at least the price per unit weight and the total price;
determining that a farmer is associated with a first unique self-sovereign identity indicator, the first unique self-sovereign identity indicator generated by a platform associated with a user interface and configured for secure communication within a supply chain of the delivery;
determining the farmer is an authorized user of the platform based at least in part on the first unique self-sovereign identity indicator;
identifying the acquirer involved with the supply chain based at least in part on a second unique self-sovereign identity associated with the acquirer;
causing the user interface to display an indication that the farmer and the acquirer are authorized users of the platform;
in response to receiving an indication that the acquirer has acquired the delivery of the commodity, dynamically generating an encrypted Quick Response (QR) code specific to the delivery and, when scanned, providing information associated with the delivery, the acquirer, and the farmer; and
causing the user interface to display the QR code in association with the delivery.

7. The method as recited in claim 6, further comprising:
displaying the user interface,
and wherein:
determining the first weight associated with the delivery comprises receiving, using a first interface element of the user interface, a first input indicating the first weight associated with the delivery; and
determining the conversion factor associated with the delivery comprise receiving, using a second interface element of the user interface, a second input indicating the conversion factor associated with the delivery.

8. The method as recited in claim 7, further comprising:
displaying, using the user interface, an indication of the first weight associated with the delivery;
displaying, using the user interface, an indication of the conversion factor;
displaying, using the user interface, an indication of the second weight;
displaying, using the user interface, an indication of the price per unit weight;
displaying, using the user interface, an indication of the total price; and
displaying, using the user interface, an indication of the geographic location.

9. The method as recited in claim 7, wherein the user interface is a first user interface, and wherein the method further comprises:
displaying a second user interface, the second user interface including interface elements associated with users involved with a supply chain of the delivery; and
receiving an input selecting an interface element associated with a user,
and wherein displaying the first user interface is based at least in part on the input.

10. The method as recited in claim 6, further comprising sending, to one or more devices, the data representing the at least the price per unit weight and the total price, wherein sending the data is for approval by the deliverer.

11. The method as recited in claim 6, wherein:
determining the first weight associated with the delivery comprises determining a gross weight associated with the delivery; and
determining the second weight associated with the delivery comprises determining, based at least in part on the gross weight and the conversion factor, a virtual green weight associated with the delivery.

12. The method as recited in claim 6, wherein:
determining the first weight associated with the delivery comprises determining a gross weight associated with a shipment of a commodity; and
determining the second weight associated with the delivery comprises determining, based at least in part on the gross weight and the conversion factor, a virtual green weight associated with the shipment of coffee beans.

13. The method as recited in claim 6, wherein the delivery is associated with a code, the code for viewing information associated with the delivery between the producer and a consumer.

14. The method as recited in claim 6, wherein determining the price per unit weight for the producer associated with the delivery comprises receiving, from one or more devices, data representing the price per unit weight for the producer associated with the delivery.

15. The method as recited in claim 6, further comprising:
receiving additional data representing a protected digital ledger associated with the delivery; and
displaying at least a portion of the protected digital ledger, the at least the portion of the protected digital ledger including at least the price per unit weight and the total price.

16. An electronic device comprising:
a display;
one or more processors; and
one or more computer-readable media storing instructions that, when executed by the one or more processors, cause the electronic device to perform operations comprising:
receiving a first input indicating a first weight associated with a delivery;
causing the display to present an indication of the first weight;
receiving a second input indicating a dynamic conversion factor associated with the delivery;
causing the display to present an indication of the percentage;
determining a second weight associated with the delivery based at least in part on the first weight and the dynamic conversion factor;
determining a price per unit weight for a producer associated with the delivery, wherein the price per unit weight is determined based at least in part on (1) dynamically-changing pricing information specific to the geographic location of the electronic device at the time inputs are received, (2) a varietal of a commodity associated with the delivery, (3) local exchange rate, (4) quality and (5) an identifier of an acquirer;
determining a total price for the producer based at least in part on the second weight and the price per unit weight;
determining that a farmer is associated with a first unique self-sovereign identity indicator, the first unique self-sovereign identity indicator generated by a platform associated with a user interface and configured for secure communication within a supply chain of the delivery;
determining the farmer is an authorized user of the platform based at least in part on the first unique self-sovereign identity indicator;
identifying the acquirer involved with the supply chain based at least in part on a second unique self-sovereign identity associated with the acquirer;
causing the user interface to display an indication that the farmer and the acquirer are authorized users of the platform;
in response to receiving an indication that the acquirer has received the delivery, dynamically generating an encrypted Quick Response (QR) code specific to the delivery and, when scanned, providing information associated with the delivery, the acquirer, and the farmer; and
causing the user interface to display the QR code in association with the delivery.

17. The electronic device as recited in claim 16, the operations further comprising:
causing the display to present the user interface,
and wherein:
receiving the first input comprises receiving, using a first interface element associated with the user interface, the first input indicating the first weight associated with the delivery; and
receiving the second input comprises receiving, using a second interface element associated with the user interface, the second input indicating the factor associated with the delivery.

18. The electronic device as recited in claim 17, the operations further comprising:
causing the user interface to display, using a third interface element associated with the user interface, an indication of the price per unit weight for the deliverer; and
causing the user interface to display, using a fourth interface element associated with the user interface, an indication of the total price for the producer.

19. The electronic device as recited in claim 16, the operations further comprising:
receiving a third input indicating inputting information associated with the delivery is complete, the information including at least one of the first weight, the conversion factor, the second weight, the geographic location, varietal, certification(s), harvest month, the price per unit weight, or the total price; and
sending, to one or more computing devices, data representing the information.

20. The electronic device as recited in claim 16, wherein:
the delivery includes a delivery of coffee;
the first weight includes a gross weight associated with the delivery of coffee;
the conversion factor includes a mill percentage associated with the delivery of commodity; and
the second weight includes a virtual green weight associated with the delivery of the commodity.
